(19) United States
(12) Patent Application Publication
(10) Pub. No.: US 2015/0224510 A1
(43) Pub. Date: Aug. 13, 2015

(54) CLASSIFIER-EQUIPPED MEDIA-AGITATION TYPE PULVERIZER

(71) Applicant: ASHIZAWA FINETECH LTD., Narashino-shi, Chiba (JP)

(72) Inventors: Tsuyoshi Ishikawa, Narashino-shi (JP); Naoki Hagiwara, Narashino-shi (JP)

(21) Appl. No.: 14/124,424

(22) PCT Filed: Feb. 19, 2013
(86) PCT No.: PCT/JP2013/053975

§ 371 Date: Dec. 6, 2013

(30) Foreign Application Priority Data
Nov. 21, 2012 (JP) 2012-254826

(51) Int. Cl. B02C 17/16; B02C 17/18

(52) U.S. Cl. CPC B02C 17/161; B02C 17/166; B02C 17/189; B02C 17/188

(57) ABSTRACT

Provided is a classifier-equipped media-agitation type pulverizer, which is capable of moving up pulverized particles to a classification section by supplying a secondary gas in an amount less than ever before, thereby enhancing classification capability of a classifying wheel.

Solution

A classifier-equipped media-agitation type pulverizer of the present invention comprises: a pulverization section disposed in a lower portion of a tubular container; a classification section disposed in an upper portion of the tubular container; a vessel housed inside the pulverization section, and having an agitator member disposed thereinside to pulverize a raw material; at least one secondary gas inlet port provided in the pulverization section; a classifying wheel for wheel-rotation type product classification disposed in the classification section; a fine powder discharge passage connected to the classification section so as to discharge a classified fine powder therethrough; an upward passage for leading particles subjected to the pulverization, from the pulverization section to the classification section; and a downward passage for returning a coarse powder which has not been collected by the classification section, from the classification section to the pulverization section. The agitator member has a cylindrical rotor body rotatably disposed in the vessel to extend vertically, while defining an annular pulverization chamber between an outer periphery of the cylindrical rotor body and an inner periphery of the vessel, and a circulation mechanism is provided between the pulverization section and the classification section to promote a flow of carrier gas carrying the pulverized powder, in a direction from the pulverization section to the classification section.

### TECHNICAL FIELD

The present invention relates to a classifier-equipped media-agitation type pulverizer. The classifier-equipped media-agitation type pulverizer of the present invention is particularly suitable for use in, but not limited to, mixing a raw material, such as pigment, ceramics, metal, inorganic material, ferrite, toner carrier, electronic material, battery material, plaster, slag, silicon, glass, or carbon, with pulverizing/dispersing media in the form of beads, to pulverize or disperse the raw material into fine particles, and then classifying the fine particles.

### BACKGROUND ART

As one example, there has been known a classifier-equipped media-agitation type pulverizer, as disclosed in JP 2003-265975 A. The classifier-equipped media-agitation type pulverizer disclosed in the patent publication is a dry media-agitation type pulverizer for agitating a raw material together with media by an agitator, thereby pulverizing the raw material, wherein the pulverizer comprises: a pulverization section comprised of a pulverization chamber formed in an upright tubular shape having an upper opening and a bottom portion with a fluidizing gas (secondary gas) supply port, and an agitator rotatably provided inside the pulverization chamber; and a classification section comprised of a classification chamber connected to the upper opening of the pulverization chamber, a classifying rotor rotatably provided within the classification chamber, and a product collection pipe connected to the classifying rotor while penetrating from an outside to inside of the classification chamber.

Generally, in such a classifier-equipped pulverizer, a secondary air (fluidizing gas) is required to move up pulverized particles pulverized in an agitation portion, from the agitation portion to the classification section. In this regard, the classifier-equipped pulverizer disclosed in the above patent publication is configured to introduce most of the secondary air from a circular vane located nearby the classifying rotor, and therefore an amount of secondary air is liable to become insufficient. On the other hand, a satisfactory amount of secondary air can be obtained by largely increasing an air volume of the classifying rotor. However, this exerts a negative influence on classification accuracy.

### LIST OF PRIOR ART DOCUMENTS

### Patent Documents

Patent Document 1: JP 2003-265975A

### SUMMARY OF THE INVENTION

### Technical Problem

It is an object of the present invention to provide a classifier-equipped media-agitation type pulverizer capable of moving up pulverized particles to a classification section by supplying a secondary gas in an amount less than ever before, thereby enhancing classification capability of a classifying wheel.

### Solution to the Technical Problem

The above object is achieved by a classifier-equipped media-agitation type pulverizer having the following features (1) to (11)

(1)

A classifier-equipped media-agitation type pulverizer comprises: a pulverization section disposed in a lower portion of a tubular container; a classification section disposed in an upper portion of the tubular container; a vessel housed inside the pulverization section and having an agitator member disposed thereinside to pulverize a raw material; at least one secondary gas inlet port provided in the pulverization section; a classifying wheel for wheel-rotation type product classification disposed in the classification section; a fine powder discharge passage connected to the classification section so as to discharge a classified fine powder therethrough; an upward passage for leading particles subjected to the pulverization, from the pulverization section to the classification section; and a downward passage for returning a coarse powder which has not been collected by the classification section, from the classification section to the pulverization section. The classifier-equipped media-agitation type pulverizer is characterized in that: the agitator member has a cylindrical rotor body rotatably disposed in the vessel to extend vertically, while defining an annular pulverization chamber between an outer periphery of the cylindrical rotor body and an inner periphery of the vessel; and a circulation mechanism is provided between the pulverization section and the classification section to promote a flow of carrier gas carrying the pulverized powder, in a direction from the pulverization section to the classification section.

(2)

The classifier-equipped media-agitation type pulverizer set forth in the section (1), wherein the circulation mechanism is configured to utilize the Coanda effect.

(3)

The classifier-equipped media-agitation type pulverizer set forth in the section (1) or (2), wherein the agitator member has a plurality of rod-shaped members each attached around the cylindrical rotor body to extend in a radial direction of the cylindrical rotor body, and wherein each of the rod-shaped members has a shape in which a distal end of the rod-shaped member is thicker than a base end thereof.

(4)

The classifier-equipped media-agitation type pulverizer set forth in the section (3), wherein each of the rod-shaped members has a shape selected from the group consisting of: a shape in which a diameter of the rod-shaped member gradually increases in a direction from a base end to a distal end thereof; a shape in which a spherical body is attached to a distal end of a rod-shaped body, wherein the spherical body has a diameter greater than that of the rod-shaped body; and a shape in which a columnar body is attached to the distal end of the rod-shaped body to extend in a direction orthogonal to the rod-shaped body, wherein the columnar body has a length greater than the diameter of the rod-shaped body.

(5)

The classifier-equipped media-agitation type pulverizer set forth in any one of the sections (1) to (4), wherein the vessel has an annular flange formed at an upper portion having a diameter greater than that of a vessel body, and wherein the vessel body is suspendedly supported in such a manner that an upper portion of the vessel body is fixed to the tubular container by the annular flange, and a lower portion of the vessel body is supported in a radial direction thereof by the tubular container.

(6)

The classifier-equipped media-agitation type pulverizer set forth in any one of the sections (1) to (5), wherein the vessel is made of a ceramic material.

(7)

The classifier-equipped media-agitation type pulverizer set forth in the section (6), wherein the ceramic material is at least one selected from the group consisting of alumina, alumina-zirconia, sialon, silicone nitride, silicon carbide, and zirconia.

(8)

The classifier-equipped media-agitation type pulverizer set forth in any one of the sections (1) to (7), which comprises a pulverization aid adding means provided in the downward passage for returning the coarse powder from the classification section to the pulverization section, to add a pulverization aid onto the coarse powder.

(9)

The classifier-equipped media-agitation type pulverizer set forth in any one of the sections (1) to (8), wherein the product discharge passage is connected to an upper portion of the classifying wheel and arranged to extend from above the classifying wheel to an outside of the classification section.

(10)

The classifier-equipped media-agitation type pulverizer set forth in any one of the sections (1) to (9), wherein the annular pulverization chamber has an inner radius which is from 0.50 to 0.80 of an outer radius thereof.

(11)

A classifier-equipped media-agitation type pulverizer comprises: a pulverization section disposed in a lower portion of a tubular container; a classification section disposed in an upper portion of the tubular container; a vessel housed inside the pulverization section, the vessel having an agitator member disposed thereinside to pulverize a raw material; at least one secondary gas inlet port provided in the pulverization section; a classifying wheel for wheel-rotation type product classification disposed in the classification section; a fine powder discharge passage connected to the classification section so as to discharge a classified fine powder therethrough; an upward passage for leading particles subjected to the pulverization, from the pulverization section to the classification section; and a downward passage for returning a coarse powder which has not been collected by the classification section, from the classification section to the pulverization section. The classifier-equipped media-agitation type pulverizer is characterized in that it comprises a pulverization aid adding means provided in the downward passage for returning the coarse powder from the classification section to the pulverization section, to add a pulverization aid onto the coarse powder.

### Effect Of The Invention

In the present invention, the pulverization chamber is formed in an annular shape, so that it becomes possible to, as compared to a conventional pulverizer, increase a flow rate of a secondary gas for moving up pulverized particles (on an assumption that a gas originally circulated around the pulverizer is defined as a primary gas or main gas), thereby reducing an amount of secondary gas to be supplied. This makes it possible to reduce a load of the classifying wheel, and enhance classification capability of the classifying wheel. In addition, the classification in the classifying wheel is performed by a centrifugal force and a drag from a suction gas. Thus, as an amount of the suction gas becomes smaller, the centrifugal force to be applied to a particle can be reduced, and thus a rotational speed of the classifying wheel can be reduced. Preferably, an inner radius of the annular pulverization chamber is in the range of ½ to ¾ of an outer radius thereof.

Further, in the present invention, the circulation mechanism is provided between the pulverization section and the classification section to promote a flow of secondary gas (carrier gas) for moving up pulverized particles from the pulverization section to the classification section, so that it becomes possible to form a smooth flow of the carrier gas (secondary gas) and the powder. The circulation mechanism may be configured to utilize the Coanda effect. In this case, an amount of air 7 to 10 times an amount of supplied secondary gas can be sucked. Thus, even if the pulverization chamber is formed in the above shape, and an amount of secondary gas to be supplied to the pulverization chamber is reduced, pulverized particles can be sufficiently moved up from the pulverization section to the classification section by the reduced secondary gas.

As above, an amount of carrier gas in the classification section can be reduced to a minimum level, so that an amount of gas equal to or greater than that supplied from the outside is ejected, and a resulting excess gas is circulated. This makes it possible to form a flow of particle-containing gas inside a main body of the pulverizer.

In the present invention, the agitator member may have a plurality of rod-shaped members each attached around the cylindrical rotor body to extend in a radial direction of the cylindrical rotor body, wherein each of the rod-shaped members may have a shape in which a distal end of the rod-shaped member is thicker than a base end thereof, for example: a shape in which a diameter of the rod-shaped member gradually increases in a direction from a base end to a distal end thereof; a shape in which a spherical body is attached to a distal end of a rod-shaped body, wherein the spherical body has a diameter greater than that of the rod-shaped body; and a shape in which a columnar body is attached to the distal end of the rod-shaped body to extend in a direction orthogonal to the rod-shaped body, wherein the columnar body has a length greater than the diameter of the rod-shaped body. In this case, each of the rod-shaped members brings out good pulverization capability based on an outer peripheral portion thereof having a large centrifugal force and thus a large pulverizing force.

In the present invention, the vessel disposed in the lower portion of the tubular container is supported in a suspended manner, so that it becomes possible to respond to a situation where the vessel elongates in an axial direction thereof due to thermal expansion, and facilitate sealing with respect to the tubular container. In addition, this structure makes it easy to use a ceramic material.

In the present invention, the vessel may be made of a ceramic material, particularly, at least one selected from the group consisting of alumina, alumina-zirconia, sialon, silicone nitride, silicon carbide, and zirconia. In this case, the vessel advantageously exhibits excellent heat resistance and becomes less likely to undergo heat expansion.

Coarse particles returned from the classification section to the pulverization section involve a large amount of carrier gas (air), and therefore become difficult for pulverizing media to capture them. In the present invention, the pulverization aid adding means may be provided in the downward passage for returning the coarse powder from the classification section to the pulverization section, to add a pulverization aid onto the coarse powder, thereby increasing a frictional coefficient of the particles and a binding force of the pulverizing media and others, to allow pulverizing energy to be easily transferred to the particles, so that the pulverization capability is enhanced. Preferably, water is used as the pulverization aid. When water is used as the pulverization aid, it brings out a cooling function based on latent heat of vaporization, in addition to the function as the pulverization aid.

As mentioned above, in the present invention, the structure of the agitator member is improved, and the pulverization aid is added to increase the frictional coefficient and the binding force of the pulverizing media. Thus, it is enough for the vessel defining the pulverization chamber to have a straight tube shape, so that it becomes possible to reduce a production cost.

### BRIEF DESCRIPTION OF THE DRAWINGS

FIG. 1 is a diagram illustrating a structure of a classifier-equipped media-agitation type pulverizer according to one embodiment of the present invention.

### DESCRIPTION OF EMBODIMENTS

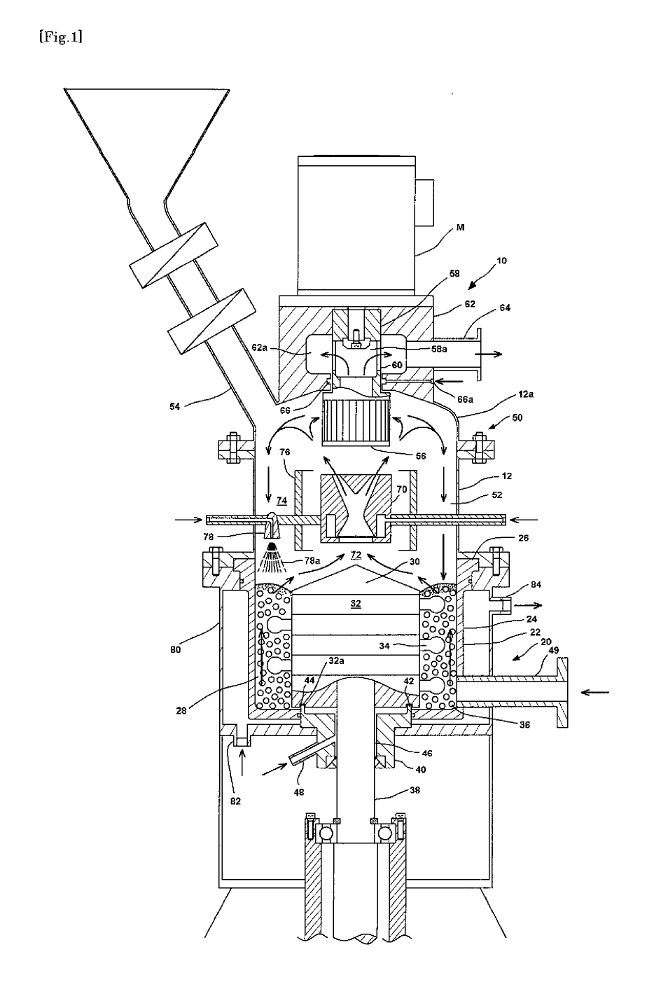

With reference to the accompanying FIG. 1, a classifier-equipped media-agitation type pulverizer according to one embodiment of the present invention will now be described in detail.

The classifier-equipped media-agitation type pulverizer (hereinafter abbreviated as “media-agitation type pulverizer”) 10 according to the embodiment of the present invention is a vertical type comprising a tubular container 12 extending vertically.

The tubular container 12 is provided with a pulverization section 20 and a classification section 50 for wheel-rotation type product classification which are disposed, respectively, in a lower portion and an upper portion thereof.

A vessel 22 is housed inside the pulverization section 20, i.e., housed inside the lower portion of the tubular container 12. The vessel 22 has a vessel body 24, and an annular flange 26 formed in an upper portion thereof to have a diameter greater than that of the vessel body 24. The vessel 22 is suspendedly supported in such a manner that an upper portion of the vessel 22 is fixed to the tubular container 12 by the annular flange 26, and a lower portion of the vessel 22 is supported in a radial direction thereof by the tubular container 12.

The vessel 22 has an internal space serving as a pulverization chamber 28, and an agitator member 30 is disposed inside the pulverization chamber 28 to pulverize a raw material. The agitator member 30 has a cylindrical rotor body 32 rotatably disposed in the pulverization chamber 28 to extend vertically, and a plurality of rod-shaped members 34 each attached around the cylindrical rotor body 32 to extend in a radial direction of the cylindrical rotor body. The cylindrical rotor body 32 may have a circular or polygonal outer shape, or may be a solid body.

The pulverization chamber 28 is defined between an inner peripheral wall of the pulverization chamber vessel 22 and an outer peripheral wall of the cylindrical rotor body 32, that is, it has an annular shape. In this manner, the pulverization chamber is formed in an annular shape having a relatively small cross-section, so that it becomes possible to, as compared to a conventional pulverizer, increase a flow rate of secondary gas for moving up pulverized particles, and reduce an amount of secondary gas to be supplied. An inner radius of the annular pulverization chamber 28 is preferably in the range of 0.50 to 0.80 of an outer radius, particularly preferably in the range of 0.55 to 0.75 of the outer radius, more preferably in the range of 0.60 to 0.75 of the outer radius.

As is well known in media-agitation type pulverizers, pulverizing media 36 in the form of beads (in the figure, they are illustrated in an extremely enlarged manner) are contained in the pulverization chamber 28 of the vessel 22.

The rod-shaped member 34 is formed in a shape in which a distal end thereof is thicker than a base end thereof. Specifically, the rod-shaped member may have: a shape in which a spherical body is attached to a distal end of a rod-shaped body, wherein the spherical body has a diameter greater than that of the rod-shaped body, as illustrated in the figure; or a shape in which a diameter of the rod-shaped member gradually increases in a direction from a base end to a distal end thereof; or a shape in which a columnar body is attached to the distal end of the rod-shaped body to extend in a direction orthogonal to the rod-shaped body, wherein the columnar body has a length greater than the diameter of the rod-shaped body. This allows the rod-shaped member to bring out good pulverization capability based on an outer peripheral portion thereof having a large centrifugal force and thus a large pulverizing force.

A rotary drive shaft 38 is attached to a lower portion of the cylindrical rotor body 32 of the agitator member 30. The rotary drive shaft 38 is disposed to extend downwardly from the lower portion of the cylindrical rotor body 32, while penetrating through the tubular container 12, and have a lower end connected to a drive source via a non-illustrated well-known drive mechanism. That is, the rotary drive shaft 38 is configured to be rotationally driven by the drive mechanism. Preferably, a rotation axis of the rotary drive shaft 38 passes through a central axis of the pulverization chamber 28.

A generally tubular-shaped support member 40 is provided in a central region of a bottom wall of the tubular container 12. The support member 40 has an upper portion formed as an annular support portion 42, and a top end of the annular support portion 42 is formed as an upwardly-extending support ring 44. The support ring 44 is fitted in an annular groove 32a formed in a bottom surface of the cylindrical rotor body 32 of the agitator member 30 to rotatably support the cylindrical rotor body 32 and thus the agitator member 30.

A slight gap is provided between an inner peripheral wall of the support member 40 and an outer peripheral wall of the rotary drive shaft 38. An air seal area 46 is formed by this gap. A sealing air supply pipe 48 is connected to the air seal area 46 to externally supply sealing air. An air-sealing function of the air seal area 46 is achieved by air from the sealing air supply pipe 48. The air from the sealing air supply pipe 48 flows into a lower region of the pulverization chamber 28 through the air seal area 46 and then a gap between the support ring 44 and the annular groove 32a to prevent particles in the pulverization chamber 28 from leaking outside the pulverization chamber 28.

A secondary air supply pipe 49 is connected to the vessel 22 to supply, into the vessel 22, a secondary air for moving up pulverized particles. The sealing air from the sealing air supply pipe 48 is also introduced into the pulverization chamber 28 to serve as the air for moving up pulverized particles.

The upper portion of the tubular container 12 makes up the classification section 50 which has an internal space serving as a classification chamber 52. A raw material supply passage 54 is connected to the classification chamber 52 to introduce a raw material therethrough. The raw material supplied from the raw material supply passage 54 is dropped into the pulverization chamber 28, and agitated together with the pulverizing media 36 and pulverized, by the agitator member 30.

A classifying wheel 56 is disposed in an upper region of the classification chamber 52. A vertically-extending rotary drive shaft 58 is fixed to a central region of a top wall of the classifying wheel 56. The rotary drive shaft 58 is disposed to extend upwardly, while penetrating through the tubular container 12, and connected to a drive source, such as an electric motor M.

The rotary drive shaft 58 has a hollow shaft portion 58a extending upwardly from the classifying wheel 56 by a given length, and an internal passage of the hollow shaft portion 58a communicates with an internal space of the classifying wheel 56. The hollow shaft portion 58a has an outlet opening 60 provided in a peripheral wall of an intermediate region thereof to lead a classified fine powder to the outside of the media-agitation type pulverizer 10. Preferably, the outlet opening 60 consists of a plurality of vertically-long slits arranged at intervals in a circumferential direction.

A cylindrical-shaped expansion chamber 62a is defined around the outlet opening 60 of the hollow shaft portion 58a by an expansion chamber defining casing 62, and a product discharge passage 64 is connected to a part of the expansion chamber 62a. According to the above structure, a classified fine powder is discharged from the internal space of the classifying wheel 56 to the outside of the classifier via the hollow shaft portion 58a, the outlet opening 60, and the fine powder discharge passage 64. The fine powder discharge passage 64 is typically formed as a line configured to suck gas by a blower through a cyclone separator and a bag filter. The fine powder is collected as a product by the cyclone separator and the bag filter.

The internal passage of the hollow shaft portion 58a also constitutes the product discharge passage 64, and the entire product discharge passage 64 is located above the classifying wheel 56.

Thus, it becomes possible to make maximum use of the internal space of the classifier. The expansion chamber 62a has a function of causing gas entering from the outlet opening 60 into the expansion chamber 62a to expand therein, thereby producing a negative pressure therein to form a smooth flow of gas from the classifying wheel 56 being rotated.

The classifying wheel 56 is supported in a suspended manner by the rotary drive shaft 58. A gap is provided between an outer peripheral surface of the rotary drive shaft 58 and an inner peripheral surface of the expansion chamber defining casing 62. An air seal area 66 is formed by this gap. The expansion chamber defining casing 62 is formed with a sealing air introduction port 66a. Sealing air supplied to the air seal area 66 is ejected into the expansion chamber 62a and the classification chamber 52 to prevent a product classified by the classifying wheel from returning from the expansion chamber 62a to the classification chamber 52, and prevent coarse particles and others which have not been classified by the classifying wheel from intruding from the classification chamber 52 into the expansion chamber 62a.

A circulation mechanism 70 is provided between the pulverization section 20 and the classification section 50 to promote a flow of carrier gas carrying pulverized particles, in a direction from the pulverization section to the classification section. The circulation mechanism 70 is designed to lead the powder from the pulverization section to the classification section by a small amount of air (carrier gas), and is preferably configured to utilize the Coanda effect.

As above, in the present invention, an upward passage 72 is provided in a central region (around an axis) of the internal space of the classifier to lead the pulverized raw material from the pulverization section to the classification section, and a downward passage 74 is provided in an outer peripheral region of the internal space of the classifier to return a coarse powder which has not been collected as a product by the classification section, from the classification section to the pulverization section. The circulation mechanism 70 is provided in the upward passage. Preferably, a partition tube 76 is provided around the circulation mechanism 70 to separate a moving-up gas flow from a moving-down gas flow so as to maximally suppress interference therebetween.

The downward passage 74 for returning a coarse powder which has not been collected as a product by the classification section, from the classification section to the pulverization section, is provided with a pulverization aid adding device 78 for adding a pulverization aid 78a such as water or alcohol, into the coarse powder. Preferably, water is used as the pulverization aid. This is because water functions as not only a pulverization aid but also a coolant based on latent heat of vaporization.

A jacket 80 is provided around an outer periphery of the pulverization chamber vessel 22 to allow a cooling medium or heat medium (typically, a cooling medium, such as cooling water) to pass therethrough so as to control an internal temperature of the pulverization chamber 28. The jacket 80 has a lower portion provided with a cooling water inlet 82 for introducing cooling water, and an upper portion provided with a cooling water outlet 84 for discharging the cooling water.

The tubular container 12 is configured to be opened by removing an upper wall portion 12a thereof, thereby facilitating maintenance therefor.

In the media-agitation type pulverizer 10 having the above structure, a raw material supplied from the raw material supply passage 54 is dropped into the pulverization chamber 28, and agitated together with the pulverizing media 36 and pulverized, by the agitator member 30.

Resulting pulverized particles are carried upwardly by a secondary air from the secondary air supply pipe 49. Then, the pulverized particles are rapidly sucked by the circulation mechanism 70 utilizing the Coanda effect, and supplied to the classification chamber 52 through the upward passage 72. In this process, the raw material formed into a fine powder through the agitation by the agitator member 30 can re-agglomerate into coarse particles. However, such coarse particles are re-broken into fine particles through the rapid suction by the circulation mechanism 70 utilizing the Coanda effect.

Among the particles supplied to the classification chamber 52, fine particles are classified by the classifying wheel 56, and discharged to the outside of the pulverizer as a product. On the other hand, coarse particles which have not been classified by the classifying wheel 56 are moved down along the downward passage 74, together with a raw material supplied from the raw material supply passage 54.

In a course of the downward movement, the pulverization aid 78a is added to the coarse powder and raw material by the pulverization aid adding means 78. Then, the coarse powder are dropped into the pulverization chamber 28 together with the raw material, and re-pulverized by the agitator member 30. In the pulverizer according to this embodiment, pulverization of a raw material is performed by repeating the above operation.

As mentioned above, in the present invention, the pulverization chamber is formed in an annular shape to reduce a cross-sectional area thereof, so that it becomes possible to, as compared to a conventional pulverizer, increase a flow rate of a secondary gas for moving up pulverized particles, thereby reducing an amount of secondary gas to be supplied. This makes it possible to reduce a load of the classifying wheel, and enhance classification capability of the classifying wheel. In addition, the classification in the classifying wheel is performed by a centrifugal force and a drag from a suction gas. Thus, as an amount of the suction gas becomes smaller, the centrifugal force to be applied to a particle can be reduced, and thus a rotational speed of the classifying wheel can be reduced.

Further, in the present invention, the circulation mechanism is provided between the pulverization section and the classification section to promote a flow of carrier gas for moving up pulverized particles from the pulverization section to the classification section, so that it becomes possible to form a smooth flow of the carrier gas and the powder. The circulation mechanism may be configured to utilize the Coanda effect. In this case, an amount of air 7 to 10 times an amount of supplied secondary gas can be sucked. Thus, even if the pulverization chamber is formed in the above shape, and an amount of secondary gas to be supplied to the pulverization chamber is reduced, pulverized particles can be sufficiently moved up from the pulverization section to the classification section by the reduced secondary gas.

### EXPLANATION OF CODES

10: classifier-equipped media-agitation type pulverizer

12: tubular container

12a: upper wall portion

20: pulverization section

22: vessel

24: vessel body

26: annular flange

28: pulverization chamber

30: agitator member

32: cylindrical rotor body

34: rod-shaped member

36: pulverizing media

38: rotary drive shaft

40: support member

42: annular support portion

44: support ring

46: air seal area

48: sealing air supply pipe

49: secondary air supply pipe

50: classification section

52: classification chamber

54: raw material supply passage

56: classifying wheel

58: rotary drive shaft

58a: hollow shaft portion

60: outlet opening

62: expansion chamber defining casing

62a: expansion chamber

64: fine powder discharge passage

66: air seal area

66a: introduction port

70: circulation mechanism

72: upward passage

74: downward passage

76: partition tube

78: pulverization aid adding device

80: jacket

82: cooling water inlet

84: cooling water outlet

1. A classifier-equipped media-agitation type pulverizer comprising:
a pulverization section disposed in a lower portion of a tubular container;
a classification section disposed in an upper portion of the tubular container;
a vessel housed inside the pulverization section, the vessel having an agitator member disposed thereinside to pulverize a raw material, and at least one secondary gas inlet port provided;
a classifying wheel for wheel-rotation type product classification disposed in the classification section;
a fine powder discharge passage connected to the classification section so as to discharge a classified fine powder therethrough;
an upward passage for leading particles subjected to the pulverization, from the pulverization section to the classification section; and
a downward passage for returning a coarse powder which has not been collected by the classification section, from the classification section to the pulverization section,
the classifier-equipped media-agitation type pulverizer being characterized in that:
the agitator member has a cylindrical rotor body rotatably disposed in the vessel to extend vertically, while defining an annular pulverization chamber between an outer periphery of the cylindrical rotor body and an inner periphery of the vessel; and
a circulation mechanism is provided between the pulverization section and the classification section to promote a flow of carrier gas carrying the pulverized powder, in a direction from the pulverization section to the classification section.

2. The classifier-equipped media-agitation type pulverizer as defined in claim 1, wherein the circulation mechanism is configured to utilize the Coanda effect.

3. The classifier-equipped media-agitation type pulverizer as defined in claim 1, wherein the agitator member has a plurality of rod-shaped members each attached around the cylindrical rotor body to extend in a radial direction of the cylindrical rotor body, each of the rod-shaped members having a shape in which a distal end of the rod-shaped member is thicker than a base end thereof.

4. The classifier-equipped media-agitation type pulverizer as defined in claim 3, wherein each of the rod-shaped members has a shape selected from the group consisting of: a shape in which a diameter of the rod-shaped member gradually increases in a direction from a base end to a distal end thereof; a shape in which a spherical body is attached to a distal end of a rod-shaped body, wherein the spherical body has a diameter greater than that of the rod-shaped body; and a shape in which a columnar body is attached to the distal end of the rod-shaped body to extend in a direction orthogonal to the rod-shaped body, wherein the columnar body has a length greater than the diameter of the rod-shaped body.

5. The classifier-equipped media-agitation type pulverizer as defined in claim 1, wherein the vessel has an annular flange formed at an upper portion having a diameter greater than that of a vessel body, the vessel body being suspendedly supported in such a manner that an upper portion of the vessel body is fixed to the tubular container by the annular flange, and a lower portion of the vessel body is supported in a radial direction thereof.

6. The classifier-equipped media-agitation type pulverizer as defined in claim 1, wherein the vessel is made of a ceramic material.

7. The classifier-equipped media-agitation type pulverizer as defined in claim 6, wherein the ceramic material is at least one selected from the group consisting of alumina, alumina-zirconia, sialon, silicone nitride, silicon carbide, and zirconia.

8. The classifier-equipped media-agitation type pulverizer as defined in claim 1, which comprises a pulverization aid adding means provided in the downward passage for returning the coarse powder from the classification section to the pulverization section, to add a pulverization aid onto the coarse powder.

9. The classifier-equipped media-agitation type pulverizer as defined in claim 1, wherein the product discharge passage is connected to an upper portion of the classifying wheel and arranged to extend from above the classifying wheel to an outside of the classification section.

10. The classifier-equipped media-agitation type pulverizer as defined in claim 1, wherein the annular pulverization chamber has an inner radius which is from 0.50 to 0.80 of an outer radius thereof.

11. A classifier-equipped media-agitation type pulverizer comprising:
a pulverization section disposed in a lower portion of a tubular container;
a classification section disposed in an upper portion of the tubular container;
a vessel housed inside the pulverization section, the vessel having an agitator member disposed thereinside to pulverize a raw material;
at least one secondary gas inlet port provided in the pulverization section;
a classifying wheel for wheel-rotation type product classification disposed in the classification section;
a fine powder discharge passage connected to the classification section so as to discharge a classified fine powder therethrough;
an upward passage for leading particles subjected to the pulverization, from the pulverization section to the classification section; and
a downward passage for returning a coarse powder which has not been collected by the classification section, from the classification section to the pulverization section,
the classifier-equipped media-agitation type pulverizer being characterized in that it comprises a pulverization aid adding means provided in the downward passage for returning the coarse powder from the classification section to the pulverization section, to add a pulverization aid onto the coarse powder.
